(19) United States
(12) Patent Application Publication
(10) Pub. No.: US 2014/0207698 A1
(43) Pub. Date: Jul. 24, 2014

(54) SYSTEM, METHOD AND COMPUTER PROGRAM PRODUCT FOR AUTOMATICALLY EVALUATING PROSPECTIVE EMPLOYEES

(71) Applicant: Salesforce.com, Inc., San Francisco, CA (US)

(72) Inventors: Taylor Geisse, San Francisco, CA (US); Neal Narayani, San Francisco, CA (US)

(73) Assignee: Salesforce.com, Inc., San Francisco, CA (US)

(21) Appl. No.: 14/160,470

(22) Filed: Jan. 21, 2014

Related U.S. Application Data
(60) Provisional application No. 61/754,898, filed on Jan. 21, 2013.

(51) Int. Cl. G06Q 10/10

(52) U.S. Cl. CPC G06Q 10/1053
USPC 705/321

(57) ABSTRACT

In accordance with embodiments, there are provided mechanisms and methods for automatically evaluating prospective employees. These mechanisms and methods for automatically evaluating prospective employees can reduce the amount of time to evaluate prospective employees, as opposed to evaluation techniques the include manual processes, as well as to provide consistent evaluation standards.

### CLAIM OF PRIORITY

This application claims the benefit of U.S. Provisional Patent Application No. 61/754,898 entitled “Systems and Methods for Evaluating Talent in an On-demand Services Environment,” by Giesse et al., filed Jan. 21, 2013 (Attorney Docket No. 1114PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to processing prospective employee information.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Conventionally, techniques for evaluating prospective employees have involved the manual process of one or more users reviewing information for each prospective employee and subjectively determining the extent to which each prospective employee should be considered for employment. Unfortunately, this manual process is time consuming, and the manner in which each prospective employee is evaluated generally varies.

Accordingly, it is desirable to provide techniques enabling an automated evaluation of prospective employees.

### BRIEF SUMMARY

In accordance with embodiments, there are provided mechanisms and methods for automatically evaluating prospective employees. These mechanisms and methods for automatically evaluating prospective employees can enable embodiments to reduce the amount of time to evaluate prospective employees, as opposed to evaluation techniques the include manual processes, as well as to provide consistent evaluation standards.

In an embodiment and by way of example, a method for evaluating prospective employees is provided. In use, profile information for at least one prospective employee is identified. Additionally, the profile information for each prospective employee is automatically evaluated, using a preconfigured algorithm. Further, identification information for at least a subset of the prospective employees is returned, based on the evaluation.

While one or more implementations and techniques are described with reference to an embodiment in which evaluating prospective employees is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for evaluating prospective employees, in accordance with an embodiment;

FIG. 2 illustrates an operational flow for evaluating prospective employees, in accordance with an embodiment;

FIGS. 3A-3B illustrate exemplary graphical user interfaces (GUIs) for logging a recruiter into a system having profiles for prospective employees and for displaying to the recruiter a summary of requested prospective employee evaluations, in accordance with an embodiment;

FIG. 4 illustrates an exemplary GUI for use by a recruiter in requesting a prospective employee evaluation, in accordance with an embodiment;

FIG. 5 illustrates an exemplary GUI for use by a researcher in receiving a request for a prospective employee evaluation, in accordance with an embodiment;

FIG. 6 illustrates an exemplary GUI for use by a researcher in executing a query to automatically evaluate prospective employees, in accordance with an embodiment;

FIG. 7 illustrates an exemplary GUI for displaying results extracted from a query that evaluated prospective employees, in accordance with an embodiment;

FIG. 8 illustrates an exemplary GUI for use by an administrator in configuring an algorithm to be used as a basis for prospective employee evaluations, in accordance with an embodiment;

FIG. 9 illustrates an exemplary GUI for use by an administrator in configuring weights for parameters included in an algorithm to be used as a basis for prospective employee evaluations, in accordance with an embodiment;

FIG. 10 illustrates a block diagram of an example of an environment wherein an on-demand database service might be used; and

FIG. 11 illustrates a block diagram of an embodiment of elements of FIG. 10 and various possible interconnections between these elements.

### DETAILED DESCRIPTION

### General Overview

Systems and methods are provided for evaluating prospective employees.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing evaluating prospective employees will be described with reference to example embodiments.

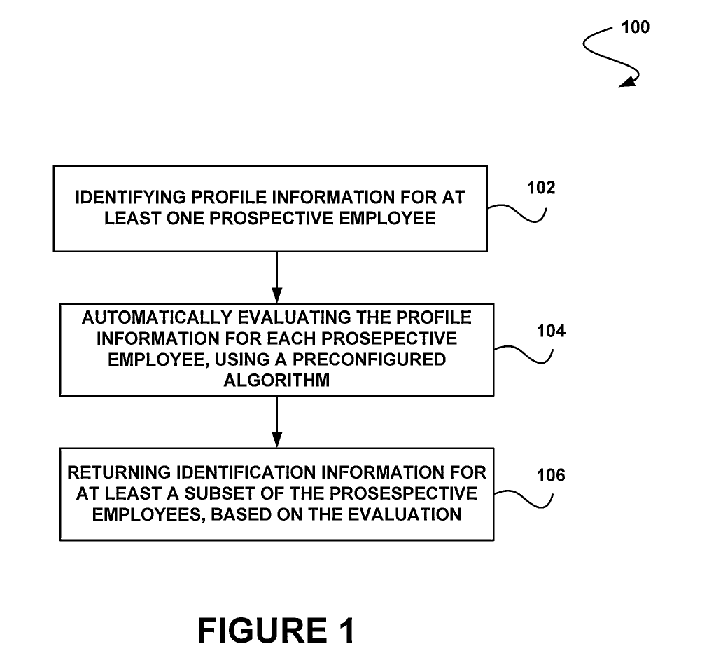

FIG. 1 illustrates a method 100 for evaluating prospective employees, in accordance with an embodiment. It should be noted that the method 100 may be performed by one or more processors (e.g. computer processors) of one or more computer devices (e.g. servers, etc.). Just by way of example, the method 100 may be performed by the multi-tenant database system described herein.

As shown in operation 102, profile information for at least one prospective employee is identified. In the context of the present description, the prospective employee is any person for which profile information is identifiable for evaluation purposes. Optionally, the prospective employee may be a user seeking employment, for example by a provider of the multi-tenant database system, by an entity (e.g. business, employer, etc.) that is a tenant (e.g. customer) of the multi-tenant database system, or by any other entity capable of employing the user.

Accordingly, the profile information may be any information that describes the prospective employee. In various embodiments, the profile information may describe or otherwise indicate a level of education of the prospective employee, educational institutions attended by the prospective employee, previous work experience of the prospective employee, skills of the prospective employee, etc. Thus, for example, the profile information may be identified from a resume of the prospective employee.

Of course, however, the profile information may be identified from any information stored in an account or profile established by the prospective employee with a profile source. Such profile source may be the multi-tenant database system, in one embodiment. In another embodiment, the profile source may be a third party entity (e.g. repository, service, etc.) separate from the multi-tenant database system, such as a social networking website, job search website, etc. To this end, the profile information may be identified from records of the profile source.

Additionally, as shown in operation 104, the profile information for each prospective employee is automatically evaluated, using a preconfigured algorithm. The algorithm may be preconfigured by an administrator, in one embodiment, for the purpose of evaluating profile information. Such administrator may be an administrator of the multi-tenant database system, as an option. As another option, the administrator may be an administrator of the entity capable of employing the user.

In any case, as noted above, the algorithm may be preconfigured for the purpose of evaluating profile information. Thus, the algorithm may be preconfigured such that it is customized for the entity (e.g. employer) for which the automatic evaluation is to be performed. For example, different algorithms may be configured for different entities to allow the evaluation of prospective employee profile information to be customized for those entities.

As an option, the algorithm may be preconfigured to include particular parameters. The parameters may indicate aspects capable of being associated with the profile information of the prospective employee. For example, the parameters may indicate a level (e.g. number of years) of prior work experience, a position held during prior work experience, prior employers of the prospective employee, keywords, etc.

As another option, the algorithm may be preconfigured to include particular weights for the above mentioned parameters. The weights may indicate the importance to be applied to the parameters. For example, a positive or negative importance may be placed on each of the parameters, for indicating that the parameter is an undesired or desired aspect, respectively. Further, varying levels of positive/negative importance may be placed on each of the parameters for indicating a specific importance for each of the different parameters.

In one embodiment, automatically evaluating the profile information may include automatically executing the preconfigured algorithm using the profile information. For example, the preconfigured algorithm may be applied to the profile information for evaluating the profile information. In the example given above where the preconfigured algorithm includes particular parameters and associated weights, the profile information may be evaluated by the algorithm identifying the parameters matching aspects of the profile information and weighting those aspects accordingly.

Further, as shown in operation 106, identification information for at least a subset of the prospective employees is returned, based on the evaluation. In particular, a result of the evaluation may be used to determine whether (or how) identification information for each prospective employee should be returned (e.g. output, displayed, etc.). Moreover, if the result of the evaluation of profile information for a prospective employee complies with (e.g. meets) a predefined requirement (e.g. threshold), then the identification information for that prospective employee may be returned.

By way of example, a score may be returned from the automatic evaluation of the profile information for each prospective employee. The prospective employee may then be ranked based on the scores returned from the automatic evaluation of the profile information for each prospective employee. The identification information for the prospective employees may be returned in an order based on the ranking. As an option, identification information may only be returned for a threshold number of the prospective employees, to limit a number of identification information of prospective employees returned as a result of the evaluations of operation 104.

By automatically performing evaluations of prospective employee profile information, as described above, the amount of time to evaluate prospective employees may be reduced, as opposed to evaluation techniques the include manual processes. Further, by using the same preconfigured algorithm to perform the evaluations, consistent evaluation standards maybe provided.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

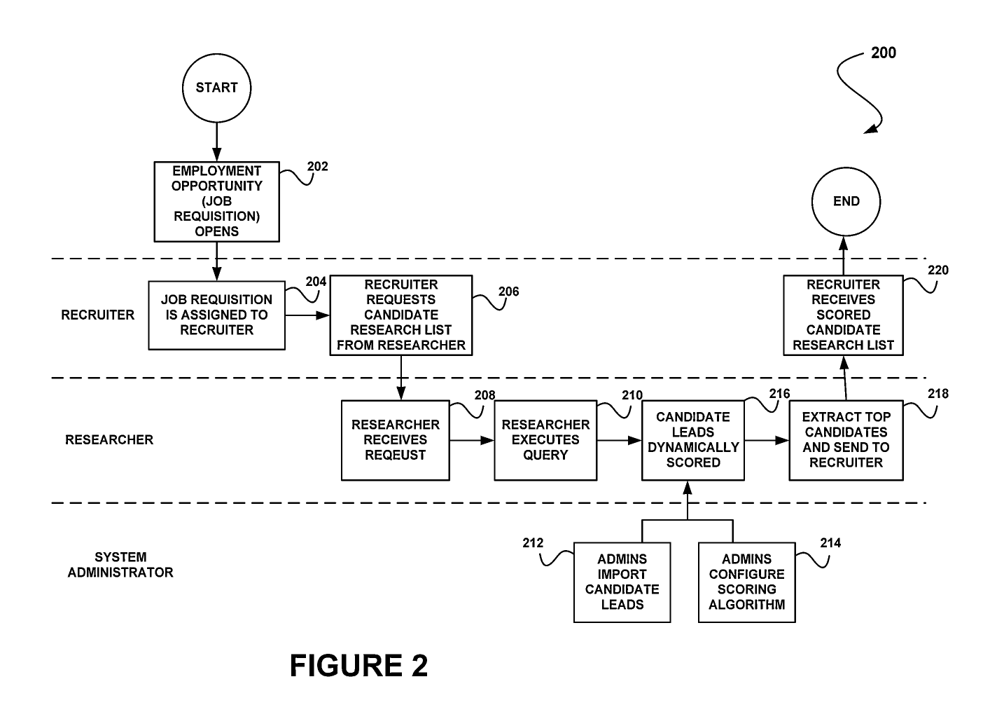

FIG. 2 illustrates an operational flow 200 for evaluating prospective employees, in accordance with an embodiment. As an option, the operational flow 200 may be implemented in the context of FIG. 1. Of course, however, the operational flow 200 may be implemented in any desired context. It should also be noted that the aforementioned definitions may apply during the present description.

As shown in operation 202, an employment opportunity (i.e. job requisition) opens. In one embodiment, the opening of such employment opportunity may be indicated by an employer or other entity entering the indication. For example, the indication may be entered in a multi-tenant database system or other system implementing the flow 200.

In operation 204, the job requisition is assigned to a recruiter. The recruiter may be a user having an account with the system such that the job requisition may be assigned to the recruiter. Further, the entity that opened the employment opportunity may assign the job requisition to the recruiter, or the recruiter may identify the job requisition in a pool of open job requisitions and may assign the job requisition to himself.

In operation 206, the recruiter requests a candidate research list from a researcher. The researcher may be another user having an account with the system such that the candidate research list can be requested from the researcher via the system. In the present embodiment, the candidate research list may be a list of identification information for prospective employees that are to be considered for the employment opportunity. Thus, the request may be for the evaluation of the profile information of prospective employees, and may optionally include requirements (e.g. parameters) for the evaluation of the profile information.

In operation 208, the researcher receives the request (e.g. via the system). Then, in operation 210, the researcher executes a query. Thus, the system may receive the query from the researcher. The query may be for the list of identification information for prospective employees that are to be considered for the employment opportunity. In the present embodiment, execution of the query may apply an algorithm to profile information of prospective employees, where the algorithm is preconfigured for the purpose of evaluating the profile information.

As shown in operation 212, which may occur prior to any of operations 202-210 of the present flow 200, one or more administrators import candidate leads (i.e. profile information for prospective employees). The candidate leads may be imported from records of the multi-tenant database system and/or from a third party entity separate from the multi-tenant database system. As shown in operation 214, which also may occur prior to any of operations 202-212 of the present flow 200, one or more administrators configure a scoring algorithm (i.e. the preconfigured algorithm) for the purpose of evaluating the profile information.

To this end, the preconfigured algorithm is applied to the imported profile information for dynamically scoring the prospective employees, as shown in operation 216. As noted above, the application of the preconfigured algorithm to the imported profile information may be performed automatically by the system in response to the receipt of the query. In operation 218, the researcher extracts the top scored candidates from results of the query and the extracted candidates are sent to the recruiter. The researcher may select a format (e.g. a list, spreadsheet, etc.) in which the top scored candidates are to be extracted, as an option. Further, the top scored candidates may be sent to the recruiter using the system.

In operation 220, the recruiter receives the top scored candidates in a scored candidate research list. The scored candidate research list may present the top scored candidates by including identification information (e.g. name, link to profile information, etc.) for the top scored prospective employees. Further, the top scored candidates may be ordered in the list based on the respective scores. To this end, the recruiter may use the scored candidate research list for further reviewing, contacting, etc. any of the prospective employees for a potential hire of the one or more of the prospective employees for the employment opportunity.

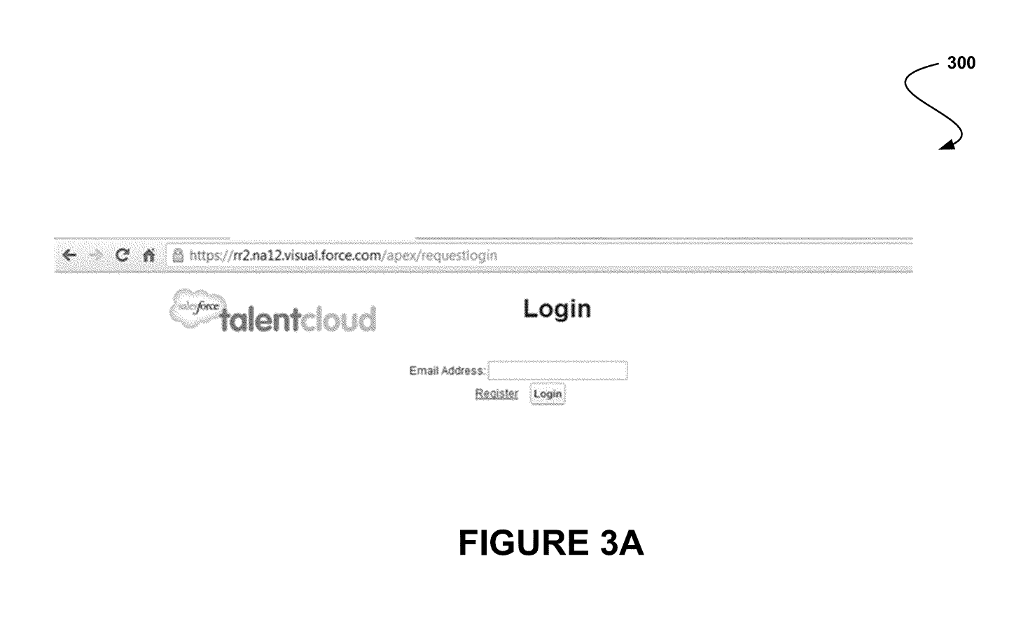

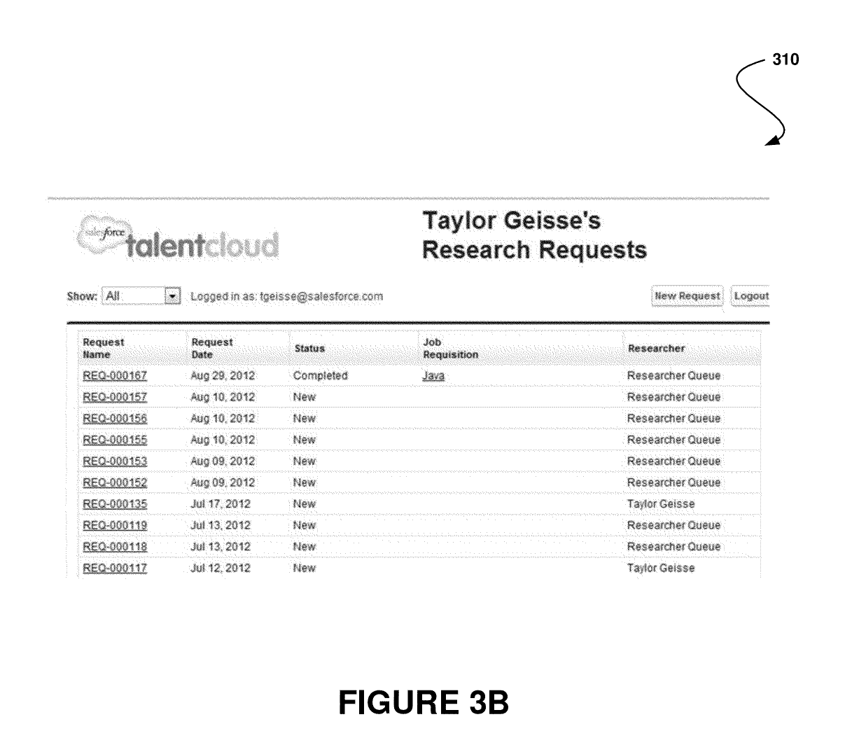

FIGS. 3A-3B illustrate exemplary graphical user interfaces (GUIs) 300-310 for logging a recruiter into a system having profiles for prospective employees and for displaying to the recruiter a summary of requested prospective employee evaluations, in accordance with an embodiment. As an option, the GUIs 300-310 may be implemented in the context of FIGS. 1-2. For example, the GUIs 300-310 may used by the recruiter for performing operation 206 of FIG. 2. Of course, however, the GUIs 300-310 may be implemented in any desired context. It should also be noted that the aforementioned definitions may apply during the present description.

As shown in GUI 300, the recruiter logs into the system using an email address of the recruiter that is registered with the system. In response to the recruiter logging in to the system, GUI 310 may be displayed which presents a summary of the recruiter's requests for prospective employee evaluations (i.e. candidate research lists). The recruiter may select a name of any of the requests via the GUI 310 for viewing another GUI (not shown) presenting details of the request. Further, the GUI 310 shows a status of each of the requests, a date in which each request was made, a job requisition for which each request is made, and a researcher to which each request is assigned. The GUI 310 also includes an option for creating a new request for a prospective employee evaluation.

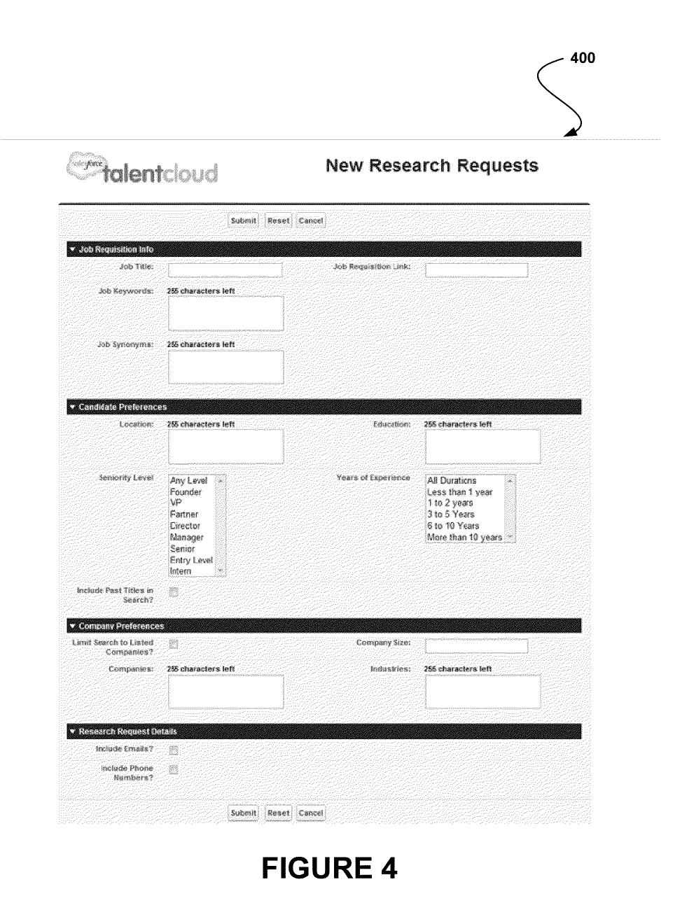

FIG. 4 illustrates an exemplary GUI 400 for use by a recruiter in requesting a prospective employee evaluation, in accordance with an embodiment. As an option, the GUI 400 may be implemented in the context of FIGS. 1-3B. For example, the GUI 400 may used by the recruiter for performing operation 206 of FIG. 2, and may optionally be displayed in response to the recruiter's selection of the option for creating a new request in GUI 310 of FIG. 3. Of course, however, the GUI 400 may be implemented in any desired context. It should also be noted that the aforementioned definitions may apply during the present description.

As shown, the GUI 400 allows the recruiter to generate a new request for the evaluation of profile information of prospective employees. The GUI 400 includes fields for allowing the recruiter to enter requirements for the evaluation of the profile information of the prospective employees. The requirements may be parameters based upon which the profile information is to be evaluated, such as years of experience required, etc. As another option, the requirements may be a format in which results of the evaluation are to be provided to the recruiter, such as whether email addresses, phone numbers, etc. of any listed prospective employees are to be included in the results.

Once the recruiter selects an option to submit the new request for the prospective employee evaluation, the request including the requirements is received by the system. Further, in response to the selection of the option, a notification (e.g. email) may be automatically sent to the recruiter that the request has been received by a team of researchers. In addition, a notification may be automatically sent to the team or researchers that the new request has been created.

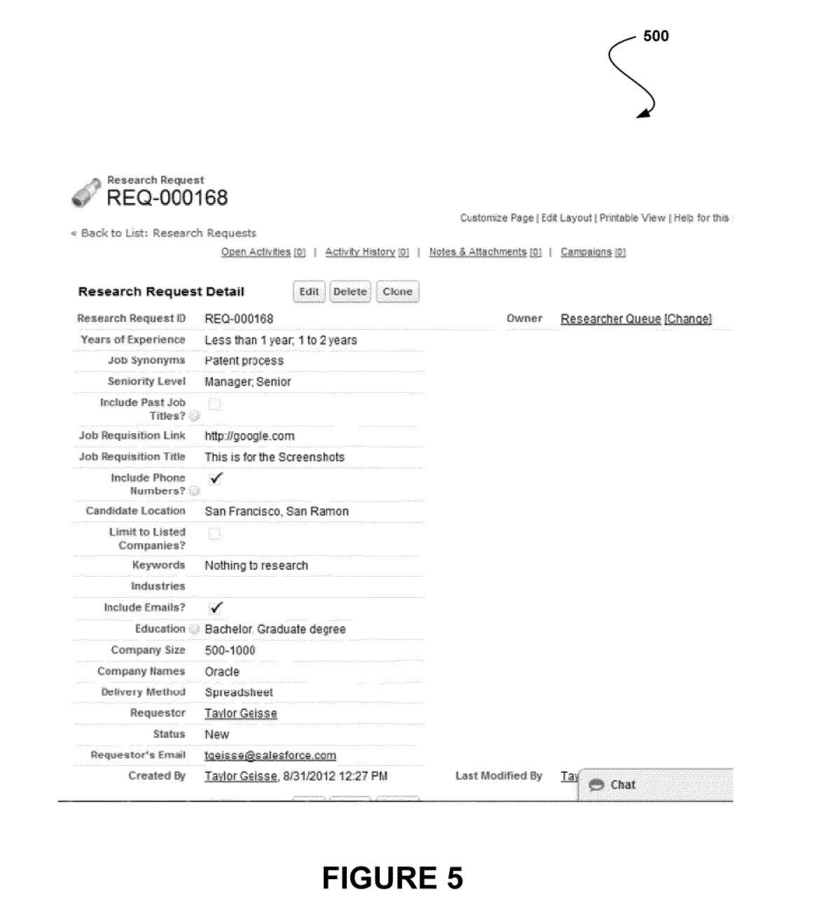

FIG. 5 illustrates an exemplary GUI 500 for use by a researcher in receiving a request for a prospective employee evaluation, in accordance with an embodiment. As an option, the GUI 500 may be implemented in the context of FIGS. 1-4. For example, the GUI 500 may used by the researcher for performing operation 208 of FIG. 2. Of course, however, the GUI 500 may be implemented in any desired context. It should also be noted that the aforementioned definitions may apply during the present description.

A team of researchers receives details of a new request for a prospective employee evaluation. One of the researchers then assigns the request to himself. The GUI 500 displays details of the request, including any requirements entered by the recruiter.

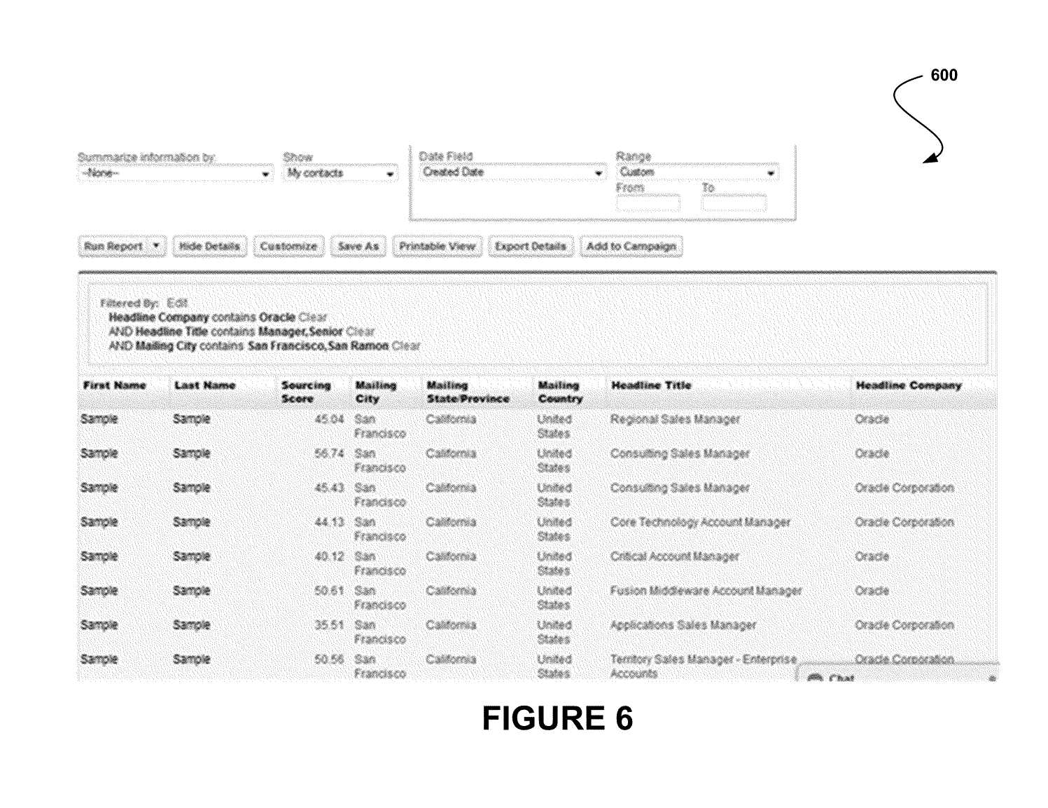

FIG. 6 illustrates an exemplary GUI 600 for use by a researcher in executing a query to automatically evaluate prospective employees, in accordance with an embodiment. As an option, the GUI 600 may be implemented in the context of FIGS. 1-5. For example, the GUI 600 may used by the researcher for performing operation 210 of FIG. 2. Of course, however, the GUI 600 may be implemented in any desired context. It should also be noted that the aforementioned definitions may apply during the present description.

As shown, the GUI 600 includes an option for the researcher to request that a report be run, or in other words that the query be executed. In response to the request, the query is received by the system. An automatic evaluation of profile information of prospective employees is then performed, in response to the query, according to any requirements entered by the recruiter. Results of the evaluation are displayed in the GUI 600, as shown. If more results are needed (e.g. a threshold number has not been returned as a result of the query), then the researcher can be notified of such in order to find profile information of additional prospective employees from other third party sources and to import such profile information to the system for evaluation thereof. Optionally, when the researcher begins execution of the query, the status of the new request for the evaluation may be marked as “In Progress” and the requestor may be notified of the new In Progress” status.

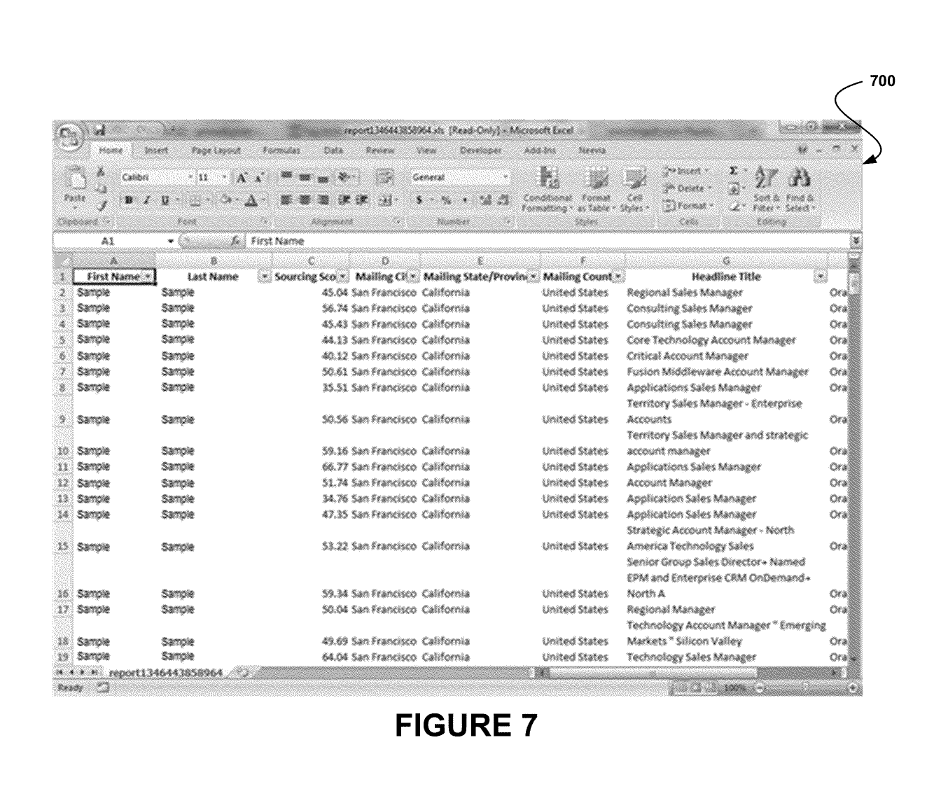

FIG. 7 illustrates an exemplary GUI 700 for displaying results extracted from a query that evaluated prospective employees, in accordance with an embodiment. As an option, the GUI 700 may be implemented in the context of FIGS. 1-6. For example, the GUI 700 may used by the researcher for performing operations 218-220 of FIG. 2, and may be displayed in response to the researcher selecting an option in the GUI 600 of FIG. 6 to export details of the query. Of course, however, the GUI 700 may be implemented in any desired context. It should also be noted that the aforementioned definitions may apply during the present description.

As shown, the results are presented in a spreadsheet, which each row including identification information for a prospective employee. As an option, the researcher may attach the spreadsheet to the recruiter's original request and may further mark the status of such request as “Complete.” The requestor may then be notified of such completed status.

It should of course be noted that the results may be presented in other formats (e.g. as requested by the researcher). Just by way of example, the results may be exported to a campaign object (e.g. record) of the system. The campaign object can then be delivered (e.g. via email, Chatter™, etc.) to the requestor.

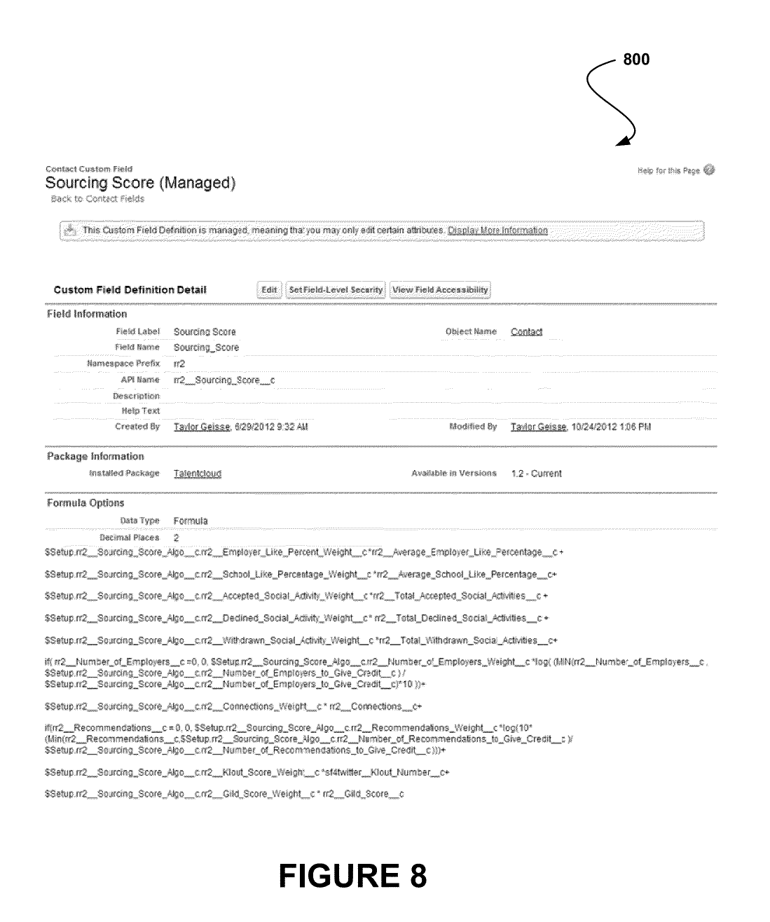

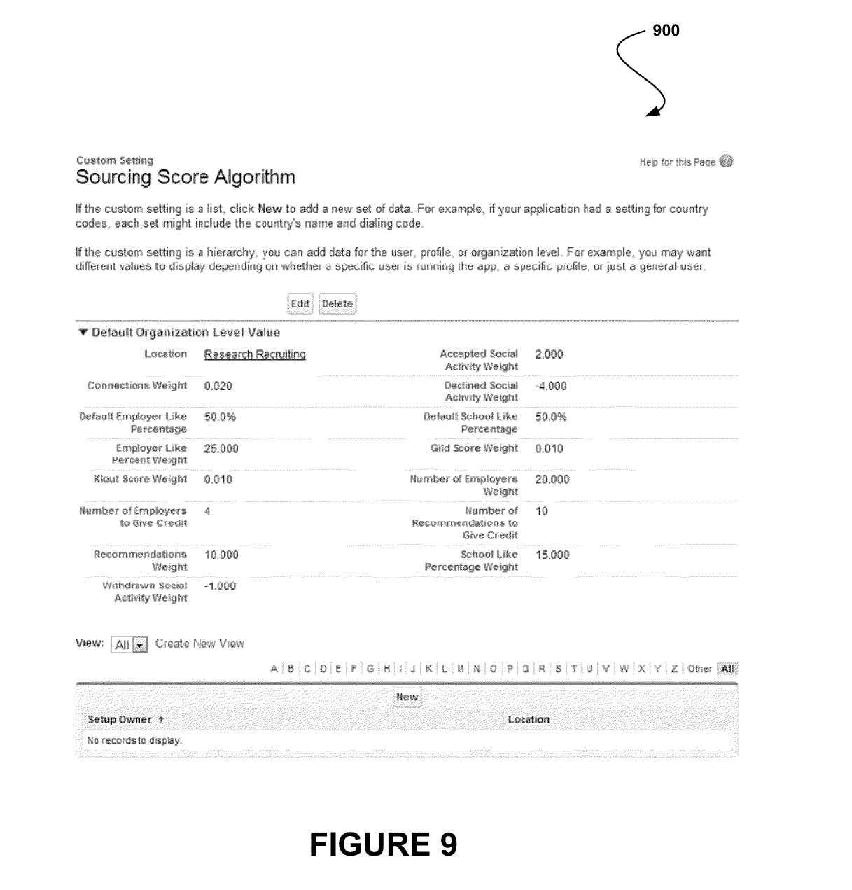

FIG. 8 illustrates an exemplary GUI 800 for use by an administrator in configuring an algorithm to be used as a basis for prospective employee evaluations, in accordance with an embodiment. Further, FIG. 9 illustrates an exemplary GUI 900 for use by an administrator in configuring weights for parameters included in an algorithm to be used as a basis for prospective employee evaluations, in accordance with an embodiment. As an option, the GUIs 800-900 may be implemented in the context of FIGS. 1-7. For example, the GUIs 800-900 may used by the researcher for performing operation 214 of FIG. 2. Of course, however, the GUIs 800-900 may be implemented in any desired context. It should also be noted that the aforementioned definitions may apply during the present description.

As shown in GUI 800, an administrator can configure the algorithm based on business needs. The algorithm is universal, thus applying the same standard to all prospective employees. In addition, as shown in operation 900, the administrator can configure weights for the parameters included in the algorithm.

### System Overview

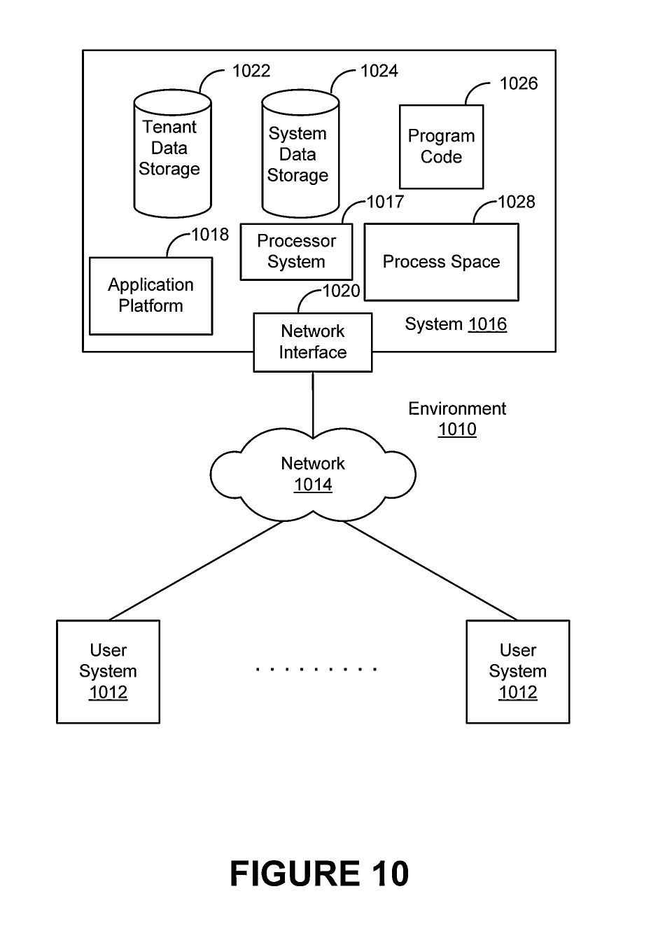

FIG. 10 illustrates a block diagram of an environment 1010 wherein an on-demand database service might be used. Environment 1010 may include user systems 1012, network 1014, system 1016, processor system 1017, application platform 1018, network interface 1020, tenant data storage 1022, system data storage 1024, program code 1026, and process space 1028. In other embodiments, environment 1010 may not have all of the components listed and/or may have other elements instead of, or in addition to, those listed above.

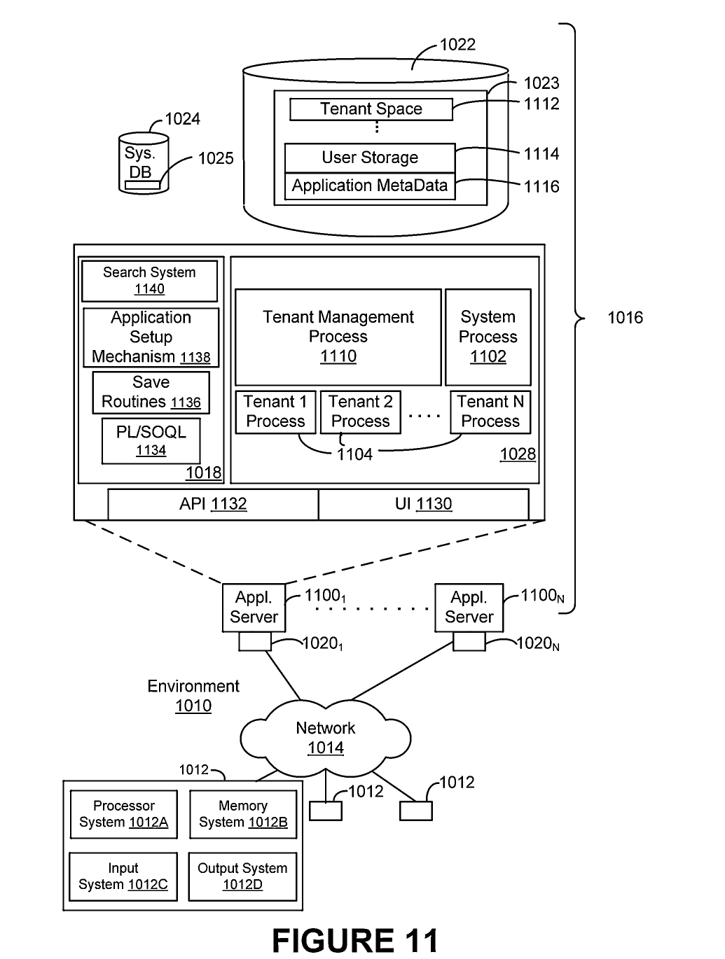

Environment 1010 is an environment in which an on-demand database service exists. User system 1012 may be any machine or system that is used by a user to access a database user system. For example, any of user systems 1012 can be a handheld computing device, a mobile phone, a laptop computer, a work station, and/or a network of computing devices. As illustrated in FIG. 10 (and in more detail in FIG. 11) user systems 1012 might interact via a network 1014 with an on-demand database service, which is system 1016.

An on-demand database service, such as system 1016, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 1016” and “system 1016” will be used interchangeably herein. A database image may include one or more database objects. A relational database management system (RDMS) or the equivalent may execute storage and retrieval of information against the database object(s). Application platform 1018 may be a framework that allows the applications of system 1016 to run, such as the hardware and/or software, e.g., the operating system. In an embodiment, on-demand database service 1016 may include an application platform 1018 that enables creation, managing and executing one or more applications developed by the provider of the on-demand database service, users accessing the on-demand database service via user systems 1012, or third party application developers accessing the on-demand database service via user systems 1012.

The users of user systems 1012 may differ in their respective capacities, and the capacity of a particular user system 1012 might be entirely determined by permissions (permission levels) for the current user. For example, where a salesperson is using a particular user system 1012 to interact with system 1016, that user system has the capacities allotted to that salesperson. However, while an administrator is using that user system to interact with system 1016, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 1014 is any network or combination of networks of devices that communicate with one another. For example, network 1014 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 1012 might communicate with system 1016 using TCP/IP and, at a higher network level, use other common Internet protocols to communicate, such as HTTP, FTP, AFS, WAP, etc. In an example where HTTP is used, user system 1012 might include an HTTP client commonly referred to as a “browser” for sending and receiving HTTP messages to and from an HTTP server at system 1016. Such an HTTP server might be implemented as the sole network interface between system 1016 and network 1014, but other techniques might be used as well or instead. In some implementations, the interface between system 1016 and network 1014 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 1016, shown in FIG. 10, implements a web-based customer relationship management (CRM) system. For example, in one embodiment, system 1016 includes application servers configured to implement and execute CRM software applications as well as provide related data, code, forms, webpages and other information to and from user systems 1012 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 1016 implements applications other than, or in addition to, a CRM application. For example, system 1016 may provide tenant access to multiple hosted (standard and custom) applications, including a CRM application. User (or third party developer) applications, which may or may not include CRM, may be supported by the application platform 1018, which manages creation, storage of the applications into one or more database objects and executing of the applications in a virtual machine in the process space of the system 1016.

One arrangement for elements of system 1016 is shown in FIG. 10, including a network interface 1020, application platform 1018, tenant data storage 1022 for tenant data 1023, system data storage 1024 for system data 1025 accessible to system 1016 and possibly multiple tenants, program code 1026 for implementing various functions of system 1016, and a process space 1028 for executing MTS system processes and tenant-specific processes, such as running applications as part of an application hosting service. Additional processes that may execute on system 1016 include database indexing processes.

Several elements in the system shown in FIG. 10 include conventional, well-known elements that are explained only briefly here. For example, each user system 1012 could include a desktop personal computer, workstation, laptop, PDA, cell phone, or any wireless access protocol (WAP) enabled device or any other computing device capable of interfacing directly or indirectly to the Internet or other network connection. User system 1012 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 1012 to access, process and view information, pages and applications available to it from system 1016 over network 1014. Each user system 1012 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 1016 or other systems or servers. For example, the user interface device can be used to access data and applications hosted by system 1016, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 1012 and all of its components are operator configurable using applications, such as a browser, including computer code run using a central processing unit such as an Intel Pentium® processor or the like. Similarly, system 1016 (and additional instances of an MTS, where more than one is present) and all of their components might be operator configurable using application(s) including computer code to run using a central processing unit such as processor system 1017, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 1016 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 1016 is configured to provide webpages, forms, applications, data and media content to user (client) systems 1012 to support the access by user systems 1012 as tenants of system 1016. As such, system 1016 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 11 also illustrates environment 1010. However, in FIG. 11 elements of system 1016 and various interconnections in an embodiment are further illustrated. FIG. 11 shows that user system 1012 may include processor system 1012A, memory system 1012B, input system 1012C, and output system 1012D. FIG. 11 shows network 1014 and system 1016. FIG. 11 also shows that system 1016 may include tenant data storage 1022, tenant data 1023, system data storage 1024, system data 1025, User Interface (UI) 1130, Application Program Interface (API) 1132, PL/SOQL 1134, save routines 1136, application setup mechanism 1138, applications servers 1100₁-1100_{N}, system process space 1102, tenant process spaces 1104, tenant management process space 1110, tenant storage area 1112, user storage 1114, and application metadata 1116. In other embodiments, environment 1010 may not have the same elements as those listed above and/or may have other elements instead of, or in addition to, those listed above.

User system 1012, network 1014, system 1016, tenant data storage 1022, and system data storage 1024 were discussed above in FIG. 10. Regarding user system 1012, processor system 1012A may be any combination of one or more processors. Memory system 1012B may be any combination of one or more memory devices, short term, and/or long term memory. Input system 1012C may be any combination of input devices, such as one or more keyboards, mice, trackballs, scanners, cameras, and/or interfaces to networks. Output system 1012D may be any combination of output devices, such as one or more monitors, printers, and/or interfaces to networks. As shown by FIG. 11, system 1016 may include a network interface 1020 (of FIG. 10) implemented as a set of HTTP application servers 1100, an application platform 1018, tenant data storage 1022, and system data storage 1024. Also shown is system process space 1102, including individual tenant process spaces 1104 and a tenant management process space 1110. Each application server 1100 may be configured to tenant data storage 1022 and the tenant data 1023 therein, and system data storage 1024 and the system data 1025 therein to serve requests of user systems 1012. The tenant data 1023 might be divided into individual tenant storage areas 1112, which can be either a physical arrangement and/or a logical arrangement of data. Within each tenant storage area 1112, user storage 1114 and application metadata 1116 might be similarly allocated for each user. For example, a copy of a user's most recently used (MRU) items might be stored to user storage 1114. Similarly, a copy of MRU items for an entire organization that is a tenant might be stored to tenant storage area 1112. A UI 1130 provides a user interface and an API 1132 provides an application programmer interface to system 1016 resident processes to users and/or developers at user systems 1012. The tenant data and the system data may be stored in various databases, such as one or more Oracle™ databases.

Application platform 1018 includes an application setup mechanism 1138 that supports application developers' creation and management of applications, which may be saved as metadata into tenant data storage 1022 by save routines 1136 for execution by subscribers as one or more tenant process spaces 1104 managed by tenant management process 1110 for example. As an option, the application platform 1018 may further include a search system 1040. Invocations to such applications may be coded using PL/SOQL 1134 that provides a programming language style interface extension to API 1132. A detailed description of some PL/SOQL language embodiments is discussed in commonly owned U.S. Pat. No. 7,730,478, entitled “METHOD AND SYSTEM FOR ALLOWING ACCESS TO DEVELOPED APPLICATIONS VIA A MULTI-TENANT ON-DEMAND DATABASE SERVICE,” issued Jun. 1, 2010 to Craig Weissman, hereby incorporated in its entirety herein for all purposes. Invocations to applications may be detected by one or more system processes, which manages retrieving application metadata 1116 for the subscriber making the invocation and executing the metadata as an application in a virtual machine.

Each application server 1100 may be communicably coupled to database systems, e.g., having access to system data 1025 and tenant data 1023, via a different network connection. For example, one application server 1100₁ might be coupled via the network 1014 (e.g., the Internet), another application server 1100_{N-1} might be coupled via a direct network link, and another application server 1100_{N} might be coupled by yet a different network connection. Transfer Control Protocol and Internet Protocol (TCP/IP) are typical protocols for communicating between application servers 1100 and the database system. However, it will be apparent to one skilled in the art that other transport protocols may be used to optimize the system depending on the network interconnect used.

In certain embodiments, each application server 1100 is configured to handle requests for any user associated with any organization that is a tenant. Because it is desirable to be able to add and remove application servers from the server pool at any time for any reason, there is preferably no server affinity for a user and/or organization to a specific application server 1100. In one embodiment, therefore, an interface system implementing a load balancing function (e.g., an F5 Big-IP load balancer) is communicably coupled between the application servers 1100 and the user systems 1012 to distribute requests to the application servers 1100. In one embodiment, the load balancer uses a least connections algorithm to route user requests to the application servers 1100. Other examples of load balancing algorithms, such as round robin and observed response time, also can be used. For example, in certain embodiments, three consecutive requests from the same user could hit three different application servers 1100, and three requests from different users could hit the same application server 1100. In this manner, system 1016 is multi-tenant, wherein system 1016 handles storage of, and access to, different objects, data and applications across disparate users and organizations.

As an example of storage, one tenant might be a company that employs a sales force where each salesperson uses system 1016 to manage their sales process. Thus, a user might maintain contact data, leads data, customer follow-up data, performance data, goals and progress data, etc., all applicable to that user's personal sales process (e.g., in tenant data storage 1022). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 1016 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 1016 might also maintain system level data usable by multiple tenants or other data. Such system level data might include industry reports, news, postings, and the like that are sharable among tenants.

In certain embodiments, user systems 1012 (which may be client systems) communicate with application servers 1100 to request and update system-level and tenant-level data from system 1016 that may require sending one or more queries to tenant data storage 1022 and/or system data storage 1024. System 1016 (e.g., an application server 1100 in system 1016) automatically generates one or more SQL statements (e.g., one or more SQL queries) that are designed to access the desired information. System data storage 1024 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, entitled “CUSTOM ENTITIES AND FIELDS IN A MULTI-TENANT DATABASE SYSTEM”, issued Aug. 27, 2010 to Craig Weissman, and hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product, comprising a non-transitory computer usable medium having a computer readable program code embodied therein, the computer readable program code adapted to be executed to implement a method, the method comprising:
identifying profile information for at least one prospective employee;
automatically evaluating the profile information for each prospective employee, using a preconfigured algorithm;
returning identification information for at least a subset of the prospective employees, based on the evaluation.

2. The computer program product of claim 1, wherein the profile information is identified from records of a multi-tenant database system that performs the automatic evaluation.

3. The computer program product of claim 1, wherein the profile information is identified from a third party repository separate from a multi-tenant database system that performs the automatic evaluation.

4. The computer program product of claim 1, wherein the profile information for each of the prospective employees is identified from a resume of the prospective employee.

5. The computer program product of claim 1, wherein the profile information describes previous work experience of the prospective employee.

6. The computer program product of claim 1, further comprising receiving a request for the evaluation of the profile information.

7. The computer program product of claim 6, wherein the request includes requirements for the evaluation of the profile information.

8. The computer program product of claim 6, further comprising receiving a query responsive to the request.

9. The computer program product of claim 8, wherein the automatic evaluation is performed in response to the receipt of the query.

10. The computer program product of claim 1, wherein the algorithm is preconfigured by an administrator.

11. The computer program product of claim 9, wherein the preconfigured algorithm is customized for an employer for which the automatic evaluation is performed.

12. The computer program product of claim 11, wherein the algorithm includes parameters that are preconfigured by the administrator.

13. The computer program product of claim 12, wherein weights are configured for the parameters included in the algorithm.

14. The computer program product of claim 1, wherein automatically evaluating the profile information includes automatically executing the preconfigured algorithm using the profile information.

15. The computer program product of claim 1, wherein a score is returned from the automatic evaluation of the profile information for each prospective employee.

16. The computer program product of claim 15, wherein the prospective employee are ranked based on the scores returned from the automatic evaluation of the profile information for each prospective employee.

17. The computer program product of claim 16, wherein the identification information for the prospective employees is returned in an order based on the ranking.

18. The computer program product of claim 1, wherein identification information is returned for a threshold number of the prospective employees.

19. A method, comprising:
identifying profile information for at least one prospective employee;
automatically evaluating, by a processor, the profile information for each prospective employee, using a preconfigured algorithm;
returning identification information for at least a subset of the prospective employees, based on the evaluation.

20. An apparatus, comprising:
a processor for:
identifying profile information for at least one prospective employee;
automatically evaluating the profile information for each prospective employee, using a preconfigured algorithm;
returning identification information for at least a subset of the prospective employees, based on the evaluation.

21. A method for transmitting code, comprising:
transmitting code for identifying profile information for at least one prospective employee;
transmitting code for automatically evaluating, by a processor, the profile information for each prospective employee, using a preconfigured algorithm;
transmitting code for returning identification information for at least a subset of the prospective employees, based on the evaluation
